(19) United States
(12) Patent Application Publication
(10) Pub. No.: US 2017/0320219 A1
(43) Pub. Date: Nov. 9, 2017

(54) Modified Blade

(71) Applicant: Stephen Gregory Baker, Goleta, CA (US)

(72) Inventor: Stephen Gregory Baker, Goleta, CA (US)

(21) Appl. No.: 15/149,160

(22) Filed: May 8, 2016

(51) Int. Cl. B26B 5/00; B23D 49/10; B23D 71/06; B26B 9/02

(52) U.S. Cl. CPC B26B 5/00; B26B 9/02; B23D 49/10; B23D 71/06

(57) ABSTRACT

A modified blade or knife that fits into a utility knife for cutting metal, wood, carpet and other materials. The blade or knife uses the utility knife body as a handle for easy, quick changing of multiple cutting edges to handle jobs that require a small tool in tight spaces without the need for power. The blades come in many common styles, fine tooth for metal, rough teeth for wood and sharp rounded blades for materials like carpet.

### REFERENCES CITED

U.S. Patent Documents

| | | | |
|---|---|---|---|
| 8,978,257 B2 | March 2015 | Quimbly et al. | 30/329 |
| 8,978,257 B2 | July 2014 | [symbol] ulf | 30/3 [symbol] 6.53 |
| 7,739,799 B2 | June 2010 | Van Deursen | 30/142 |
| 9,009,981 B2 | September 2013 | Quimbly et al. | 30/351 |
| 4,955,138 | September 1990 | Henke et al. | 30/169 |
| 9,132,492 B2 | September 2015 | Butzen, et al. | 1/1 |
| 8,776,659 B2 | July 2014 | Butzen, et al. | 83/835 |
| 8,596,166 B2 | December 2013 | Bucks et al. | 76/112 |
| D,565,369 S | April 2008 | Dawson | D8/20 |
| D687,276 S | August 2013 | Ji | D8/20 |
| D485,479 S | January 2004 | Rack | D8/20 |
| D744,794 S | December 2014 | Elliston, et al. | D8/20 |

[symbol]

indicates data missing or illegible when filed

### BACKGROUND OF THE INVENTION

### Field of Invention

The present invention relates generally to the field of cutting tools and more particularly hand cutting tools where the need for sharp cutting edges can be applied to a common utility knife and can be changed with speed and ease. The knife or blade has the appearance of a reciprocating blade but the back end has the appearance of a common utility blade which clips in to the utility knife body making the utility knife into a hand saw capable of cutting, wood metal and other materials a general a utility knife can't cut.

### SUMMARY OF THE INVENTION

The Modified Cutting Blade of the present invention overcomes the deficiencies of prior art in the field by incorporating a commonly used tool, the utility knife body as a handle for a saw blade or other attachments whereas prior art in the field requires a separate handle specifically designed to hold a specific blade manufactured by a specific company. While utility knives are useful for certain jobs like cutting cardboard and other thin materials, adding a feature for cutting metal, wood, carpet, branches and other thicker, tougher materials turns the utility knife body into a handle for cutting just about anything. As will be discussed herein, the blades can be designed with tine teeth, serrated, smooth and rough teeth for cutting different materials common utility blades won't cut.

### Description of the Preferred Embodiment

Certain embodiments of the present invention include but are not limited to will be described in detail with reference to the modified blade, as generally illustrated in FIGS. 1-5 Additional features and/or advantages of the invention will become apparent from the ensuing description or may be learned by practicing the invention. In the figures the drawings are not to scale with like numerals referring to like features throughout both the drawings and the description. Referring now to FIGS. 1-5 there is generally illustrated a reciprocating saw blade modified 1, 2 to accept a utility knife body 12 as a handle in several designs 3,4,5,6 showing the various methods blades can be manufactured to cut various materials. As the drawings of the present invention do not depict all of the possible attachments to the utility knife, drawings are shown for reference to different styles of blades 3,4,5,6 to understand and learn the present invention. While fine tooth blades and rough tooth blades are common cutting blades that can be attached to the utility knife body 12 using the present invention, other cutting knives 6 can be made to clip into the utility knife body using the present invention as well as a blade 13 made to file down material. Because the present invention uses a reciprocating style blade, adding the existing reciprocating style 7 to the opposing end of the present invention 8, 9 to attach the present invention to a utility knife body or electric reciprocating saw could be useful with teeth on both sides 10, 11 or just 10 or 11

### DESCRIPTION OF RELATED ART

On construction jobs there is many times where electric reciprocating saws can't fit in small spaces, making using electric tools difficult and sometimes impossible to use. These saws also have cutting blades for metal and wood, ranging from fine teeth to rough, using electricity to cut materials rapidly. While electricity usually makes using power tools fast and effective, power outages sometimes occur, making these tools become useless and hand tools a must. Currently in the hand tool consumer market, saws like a the hack saw for cutting metal require a hoop like handle to accept a fine blade which commonly break and are hard to get into small spaces. Some smaller metal cutting adapted blades have handles specifically designed for that blade and require the user to buy a tool with limited uses. For instance, a carpet knife typically has a wooden handle and an attached blade with a lifespan of the blade, after the blade is worn; the handle being attached to the blade, the entire tool is discarded. Utility knives currently on the market have quick change features making it easy to change the common utility knife blade with ease and speed. The utility knife is used by tradesmen and the general public for small jobs as well as large but currently there is nothing available to the consumer to attach to the utility knife body that is capable of cutting wood, metal or other materials where a saw like blade is needed. What is needed therefore is a blade with saw like properties that is capable of clipping into the common utility knife. The blade would be configured so as to look like a reciprocating saw blade but replace the common utility knife blade when needed. Most consumers will or already have purchased a utility knife capable of holding the present invention without having to require purchasing an additional handle to secure a specific saw blade or carry an additional tool while at work.

### BRIEF DESCRIPTIONS OF DRAWINGS

FIG. 1. Is a side perspective view of the present invention showing the embodiment of the modified cutting blade with end 1, 2 capable of clipping into a utility blade body and with the lower portion of the saw blade 3 showing fine teeth capable of cutting metal and other materials

FIG. 2. Is a side perspective view of the present invention with a modified saw blade and a different design shown with 5 rough teeth and the alternate end capable of clipping into the utility blade body or handle for cutting softer materials like wood and other softer materials

FIG. 3. Is a side perspective view of the present invention with a rounder knife like tip 6 for cutting carpet and other materials where said sharp round tip might be used

FIG. 4. Is a side perspective view of the present invention with a modified end 8, 9 for clipping Into the common utility knife body and the other end 7 for fastening to the common reciprocating saw for duel use 10, 11

FIG. 5. Is a perspective view of the modified blade 13 before inserting into the 12 utility knife body

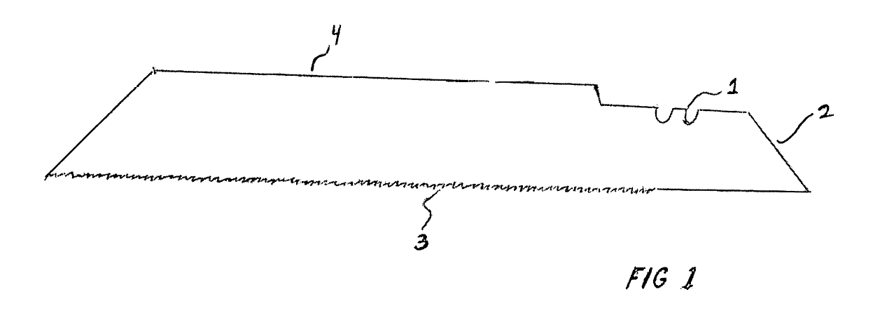

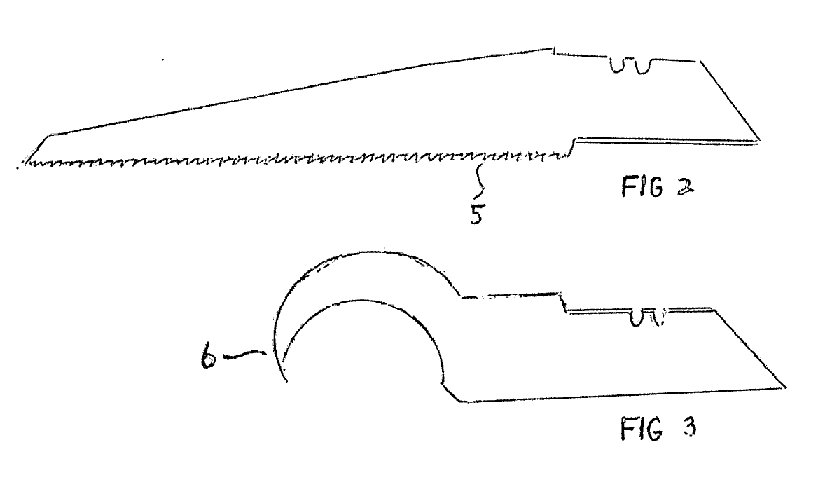

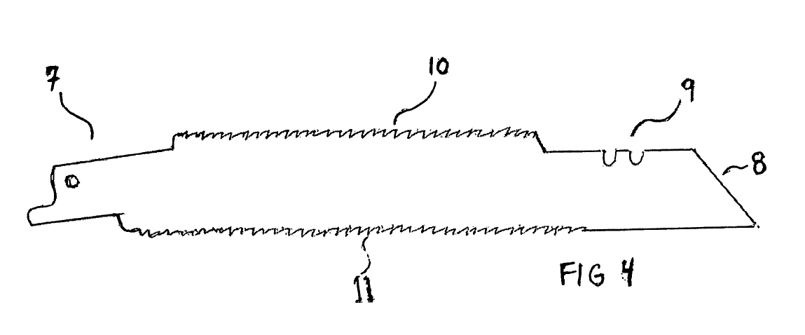

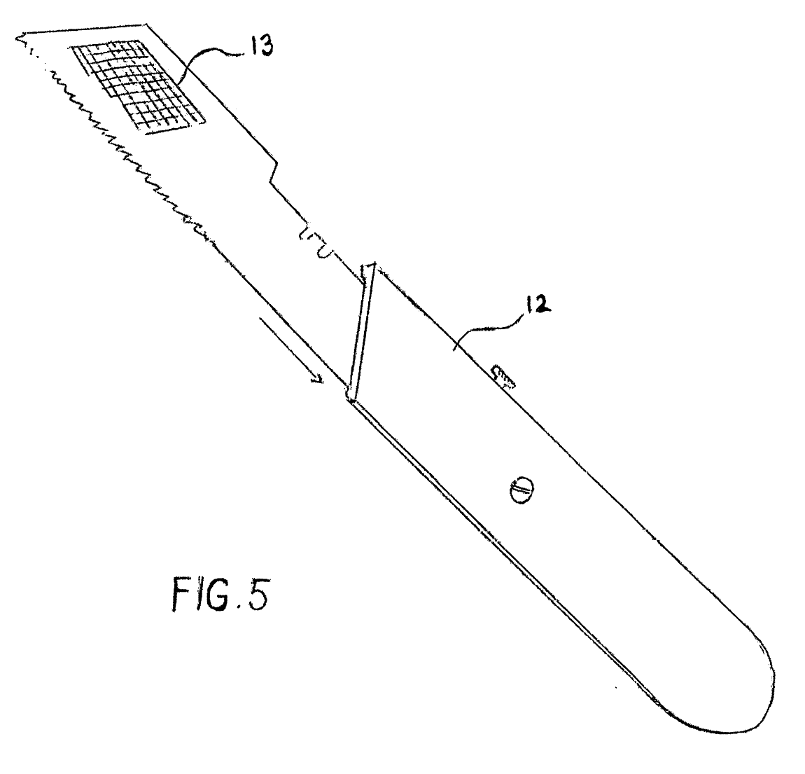

What is claimed is:

1. A modified reciprocating saw blade with said modified end clips into the body of a common utility knife body with at least one cutting edge with defined teeth.

2. A modified reciprocating saw blade with said modified end clips into the body of a common utility knife body with at least one cutting edge

3. A filing blade for filing materials incorporating the said modified end to clip into the body of a utility knife using the method of the present invention.

4. A double edge reciprocating saw blade with said modified end clips into the body of a common utility knife body on one end and the common reciprocating blade attachment on the other end for use in either tool.

5. Utility knife attachments with the modified end for the means to scrape or file using the present invention to clip into a utility knife body
